(19) United States
(12) Patent Application Publication
(10) Pub. No.: US 2025/0256310 A1
(43) Pub. Date: Aug. 14, 2025

(54) RESOURCE COMPREHENSIVE UTILIZATION PROCESS OF RED MUD, FLY ASH, STEEL SLAG AND COAL GANGUE SOLID WASTES

(71) Applicant: ZIBO YIHAI ENVIRONMENTAL PROTECTION TECHNOLOGY CO., LTD., Zibo (CN)

(72) Inventors: Bo XU, Zibo (CN); Yiming XU, Zibo (CN)

(73) Assignee: ZIBO YIHAI ENVIRONMENTAL PROTECTION TECHNOLOGY CO., LTD., Zibo (CN)

(21) Appl. No.: 19/169,040

(22) Filed: Apr. 3, 2025

Related U.S. Application Data
(63) Continuation of application No. PCT/CN2023/123286, filed on Oct. 8, 2023.

(30) Foreign Application Priority Data
Oct. 8, 2022 (CN) 202211219260.9

(51) Int. Cl. B09B 3/40; B09B 3/70; B09B 101/30; B09B 101/55

(52) U.S. Cl. CPC B09B 3/40; B09B 3/70; B09B 2101/30; B09B 2101/55

(57) ABSTRACT

The present disclosure belongs to the technical field of industrial waste solid recycling, and particularly relates to a resource comprehensive utilization process of red mud, fly ash, steel slag and coal gangue solid wastes. By using the resource comprehensive utilization process, Na₂CO₃, O₂ and a reducing agent are added into industrial waste solids for reaction and then molten iron and liquid slag water are separated; a sodium salt is added into the liquid slag water for reaction to obtain a reaction solution and sediment; the reaction solution is successively introduced into a calcium salt precipitation tank, an aluminum salt precipitation tank and a silicic acid tank and then CO₂ is introduced into the above tanks for acidification reaction, respectively, and a calcium salt, an aluminum salt, a silicic acid and an alkaline solution are obtained after filtration in sequence.

### RELATED APPLICATIONS

The present patent document is a continuation of PCT Application Serial No. PCT/CN2023/123286, filed Oct. 8, 2023, designating the United States and published in English, which is hereby incorporated by reference.

The present patent document claims the benefit of priority to patent application Ser. No. 202211219260.9, filed Oct. 8, 2022, and entitled “RESOURCE COMPREHENSIVE UTILIZATION PROCESS OF RED MUD, FLY ASH, STEEL SLAG AND COAL GANGUE SOLID WASTES,” the entire contents of each of which are incorporated herein by reference.

### BACKGROUND

### 1. Technical Field

The present disclosure belongs to the technical field of industrial waste solid recycling, and particularly relates to a resource comprehensive utilization process of red mud, fly ash, steel slag and coal gangue solid wastes.

### 2. Background Information

Red mud in the production process of aluminum oxide, fly ash in the power industry, metallurgical steel slag in the metallurgical industry, coal gangue in the energy mining industry and the like all face problems of large production volume and high treatment difficulty. At present, a common treatment method for the above solid wastes is as follows: (1) storage and landfill in a large-scale anti-seepage membrane landfill plant; (2) after being treated, a very small amount of solid wastes are used as building materials such as sand and gravel, permeable bricks, insulation cotton, insulation slag and other small products, however, most of the solid wastes have strong alkalinity while enriching lots of heavy metals, leading to low added values of the products, and a relatively small solid waste consumption capacity; and (3) solid wastes are used as compacted soil for roadbeds, but similarly the solid wastes have strong alkalinity and mingled heavy metal elements are not separated, causing environmental and safety hazards to a certain extent.

Universities, research institutes, enterprises and the like all have invested a lot of energy and money in recycling of solid wastes for extraction and utilization of one or several components of solid wastes rather than resource comprehensive utilization of solid wastes.

For example, patent CN107083485A discloses a comprehensive utilization method of aluminum oxide red mud, in which red mud is treated by using a vacuum-thermal reduction method, specifically, iron oxide in the red mud is reduced into metal iron in vacuum by using carbon or aluminum as a reducing agent, then iron in reduced slag is separated through magnetic separation and used for producing reducible iron powders, making sodium oxide in a compound state reduce into metal sodium, and the metal sodium is distilled, thereby achieving the purpose of removing alkali from the red mud and recovering alkali. Meanwhile other valuable substances (such as scandium, niobium and cesium) in the red mud are reduced into a metal state to form alloys together with aluminum, so as to be separated from a slag phase whose main components are silicon oxide and aluminum oxide, thus achieving the effects of harmless treatment of aluminum oxide red mud and comprehensive recycling utilization of valuable elements. By using this technical solution, only high contents of iron, aluminum oxide and silicon oxide in the red mud are extracted and utilized, however, the aluminum oxide red mud also contains a certain amount of metal elements with high economic values, such as calcium, magnesium and titanium, which are not extracted and utilized, and the recycled silicon oxide and aluminum oxide components are low in purity, restricting the application range of the red mud.

Patent CN102586613A discloses a method for recycling vanadium from vanadium-containing steel slag. In the method, the vanadium-containing steel slag reacts in a NaOH solution with a mass concentration of 10-50% to obtain a reaction slurry, the reaction slurry is diluted with a diluting agent to obtain a mixed slurry, then the mixed slurry is subjected to solid-liquid separation to obtain calcium-rich tail slag and a dissolution solution, a desilication agent is added into the dissolution solution to remove impurities and then subjected to solid-liquid separation so as to obtain a solution without impurities and silicon-containing slag, the solution without impurities is cooled and crystallized to obtain a sodium vanadate product. By using the method, the leaching rate of vanadium reaches 99%. However, this method is only used for extracting and utilizing vanadium in the vanadium-containing steel slag, rather than systematic recycling of other elements contained in the steel slag; furthermore, in the process of extraction, new solid wastes and a waste liquid are generated, so the resource utilization of solid wastes is not realized, resulting in a low economic value.

Thus, all the above technologies do not perform comprehensive extraction and utilization on chemical components contained in solid wastes, with a low comprehensive utilization rate of solid wastes, low economic benefits and even generation of new solid waste components during the treatment of solid wastes. Accordingly, there is a need for designing a process routine that is short in flow and balanced in economic profit and loss.

### BRIEF SUMMARY

The technical problem to be solved by the present disclosure is to provide a resource comprehensive utilization process of red mud, fly ash, steel slag and coal gangue solid wastes, which has a short treatment flow, a low energy consumption and a high product added value, and is capable of continuously treating solid wastes on large scale. No waste water or waste slag is discharged during the treatment, the resource comprehensive utilization process is green and environmental-friendly.

A resource comprehensive utilization process of red mud, fly ash, steel slag and coal gangue solid wastes provided by the present disclosure includes the following steps:
(1) heating industrial solid wastes to 1800-2400° C., then adding Na₂CO₃, O₂ and a reducing agent for reaction, so as to separate molten iron and liquid slag water;
(2) cooling the liquid slag water separated from step (1) to 30-100° C. and then feeding the cooled liquid slag water into a reactor, adding a sodium salt, reacting at 30-300° C. to obtain a reaction solution and sediment; and successively introducing the reaction solution into a calcium salt precipitation tank, an aluminum salt precipitation tank and a silicic acid tank, introducing CO₂ into the above tanks for acidification reaction, respectively, and then filtering to obtain a calcium salt, an aluminum salt, a silicic acid and an alkaline solution in sequence;
(3) concentrating and crystallizing the alkaline solution obtained in step (2), crystallizing separately to obtain a potassium salt and a sodium salt by utilizing a different saturation solubility;
(4) drying the sediment obtained in step (2), heating the dried sediment to 600-1300° C., introducing Cl₂ for reaction to obtain gaseous TiCl₄ and residue, cooling the gaseous TiCl₄ to 120° C. or below for being condensed and collected, to obtain liquid TiCl₄; and residue
(5) cyclically washing the residue obtained in step (4) with water, then performing settling separation to obtain de-magnesium residue and a magnesium chloride solution, introducing the magnesium chloride solution into a magnesium hydroxide precipitation tank, and then adding sodium hydroxide into the tank for reaction to obtain a magnesium hydroxide precipitate.

In step (1), the solid waste is one or more of red mud, fly ash, steel slag and coal gangue.

Preferably, the red mud is Bayer red mud, which comprises the following main chemical components in percentage by mass: 10-20% of Al₂O₃, 5-50% of SiO₂, 5-45% of Fe₂O₃, 1-5% of CaO, 8-14% of Na₂O, 0.2-3% of K₂O, 0.5-5% of MgO and 1-7% of TiO₂.

Preferably, the fly ash comprises the following main chemical components in percentage by mass: 3-40% of Al₂O₃, 20-40% of SiO₂, 2-20% of Fe₂O₃, 2-8% of CaO, 0.2-3% of Na₂O, 0.1-1% of K₂O, 0.2-3% of MgO and 0.2-5% of TiO₂.

Preferably, the steel slag comprises the following main chemical components in percentage by mass: 6-24% of Al₂O₃, 20-45% of SiO₂, 0.05-1% of Fe₂O₃, 20-50% of CaO, 0.2-4% of Na₂O, 0.2-3% of S, 1-13% of MgO and 0.5-15% of TiO₂.

Preferably, the coal gangue comprises the following main chemical components in percentage by mass: 20-30% of C, 10-25% of Al₂O₃, 33-43% of SiO₂, 1.5-12% of Fe₂O₃, 0.3-2% of CaO, 1-3% of Na₂O, 0.3-3% of S, 0.3-2% of MgO and 0.6-2% of TiO₂.

In step (1), a hydrogen furnace, a coke furnace or an electric arc furnace is preferably used when industrial solid wastes are heated.

In step (1), the addition amount of Na₂CO₃ is 20-80% of the mass of the industrial solid wastes.

In step (1), the addition amount of O₂ is 3-20% of the mass of the industrial solid wastes.

In step (1), the reducing agent is one or more of C, CO and H₂, and the addition amount of the reducing agent is 5-30% of the mass of the industrial solid wastes.

In step (2), the sodium salt is preferably sodium nitrate; and the addition amount of the sodium salt is 10-40% of the mass of the slag water.

In step (2), the temperatures of all the acidification reaction are 10-50° C.

In step (2), a detection instrument and a control instrument are installed in the calcium salt precipitation tank, a CO₂ introduction amount and an acidity value are controlled by detecting the numerical value of calcium ions, and the calcium salt is precisely separated to ensure that the product is pure without the doping of silicon and aluminum. The addition amount of CO₂ and acidifying reaction time are calculated based on the reaction endpoint of the calcium salt.

In step (2), a detection instrument and a control instrument are installed in the aluminum salt precipitation tank, a CO₂ introduction amount and an acidity value are controlled by detecting the numerical value of calcium ions, and the calcium salt is precisely separated to ensure that the product is pure without the doping of silicon and aluminum. The addition amount of CO₂ and acidifying reaction time are calculated based on the reaction endpoint of the aluminum salt.

In step (2), a detection instrument and a control instrument are installed in the silicic acid tank, and silicic acid is precisely separated by detecting an acidity value. The addition amount of CO₂ and acidifying reaction time are calculated based on the reaction endpoint of the silicic acid.

In step (2), the obtained calcium salt, aluminum salt and silicic acid are dried, respectively, and then further treated to obtain calcium powders, aluminum oxide and silicon dioxide.

In step (4), the addition amount of Cl₂ is 50-200% of the dry mass of the sediment.

In step (4), the liquid TiCl₄ is further treated to obtain titanium oxide.

In step (5), sodium chloride is produced from an upper-layer liquid through evaporation and concentration equipment after the precipitation is completed in the magnesium hydroxide precipitation tank.

In step (5), the magnesium hydroxide precipitate is dried to obtain magnesium oxide.

In step (5), the de-magnesium residue is a heavy metal-rich rare earth raw material.

Compared with the prior art, the present disclosure has the beneficial effects:

The resource comprehensive utilization method of the industrial waste solids according to the present disclosure adopts a chemical, physical and high-temperature incineration combining method to successively separate 8 main chemical components accounting for about 99.85% of the red mud, fly ash, steel slag and coal gangue solid wastes to obtain products such as iron, aluminum, potassium, sodium, silicon, calcium, titanium and magnesium. The resource comprehensive utilization method of the present disclosure has a short treatment flow, a low energy consumption and a high product added value, is capable of continuously treating solid wastes on large scale. No waste water or waste slag is discharged during the treatment, the resource comprehensive utilization process is green and environmental-friendly.

### DETAILED DESCRIPTION OF THE DRAWINGS AND THE PRESENTLY PREFERRED EMBODIMENTS

Next, the present disclosure will be further described in combination with embodiments.

Raw materials used in embodiments, unless otherwise specified, are commercially available conventional products; and process methods used in embodiments, unless otherwise specified, are all conventional methods in the art.

The red mud used in the examples is Bayer red mud, which comprises the following main chemical components in percentage by mass: 18.4% of Al₂O₃, 38.2% of SiO₂, 21.8% of Fe₂O₃, 2.4% of CaO, 9.5% of Na₂O, 0.8% of K₂O, 3.1% of MgO, 5.5% of TiO₂ and 0.3% of other components.

The fly ash used in the examples comprises the following main chemical components in percentage by mass: 33.6% of Al₂O₃, 35.8% of SiO₂, 15.7% of Fe₂O₃, 5.3% of CaO, 2.2% of Na₂O, 0.3% of K₂O, 2.8% of MgO, 3.5% of TiO₂ and 0.5% of other components.

The steel slag used in the examples comprises the following main chemical components in percentage by mass: 18.3% of Al₂O₃, 23.1% of SiO₂, 0.5% of Fe₂O₃, 32.4% of CaO, 2.5% of Na₂O, 0.3% of S, 12.4% of MgO, 10.1% of TiO₂ and 0.4% of other components.

The coal gangue used in the examples comprises the following main chemical components in percentage by mass: 23.6% of C, 20.3% of A₂O₃, 40.8% of SiO₂, 8.9% of Fe₂O₃, 1.2% of CaO, 1.8% of Na₂O, 0.4% of S, 1.0% of MgO, 1.2% of TiO₂ and 0.8% of other components.

### EXAMPLE 1

Industrial solid waste red mud is treated by using a resource comprehensive utilization method of the present disclosure. The treatment steps are as follows:

(1) Industrial solid wastes were heated to 2400° C. by using a hydrogen furnace, then Na2CO3, O2 and C which respectively accounted for 32.4%, 12.5% and 14.8% of the mass of the industrial solid wastes were added and reacted for 180 min, followed by separating to obtain molten iron and liquid slag water.

(2) The liquid slag water separated in step (1) was cooled to 80° C. and then fed into a reactor, sodium nitrate accounting for 24.6% of the mass of the slag water was added, and then the above materials reacted for 24 h at 200° C. to obtain a reaction solution and sediment; the reaction solution was successively introduced into a calcium salt precipitation tank, an aluminum salt precipitation tank and a silicic acid tank, CO₂ was introduced into the above tanks for acidifying reactions, respectively, the temperatures of all the acidifying reactions were set as 30° C., a CO₂ introduction amount and reaction time were adjusted according to the extent of the reaction in the tanks, a detection instrument and a control instrument were installed in the calcium salt precipitation tank, the CO₂ introduction amount and acidity value were controlled by detecting the numerical value of calcium ions, the introduction of CO₂ was ended when the content of calcium ions was detected as 0, and the aluminum salt was precisely separated to ensure the purity of the product without the doping of silicon and aluminum; the detection instrument and the control instrument were installed in the aluminum salt precipitation tank, the CO₂ introduction amount and acidity value were controlled by detecting the numerical value of aluminum ions, the introduction of CO₂ was ended when the content of aluminum ions was detected as 0, and the aluminum salt was precisely separated to ensure the purity of the product without the doping of silicon; the detection instrument and the control instrument were installed in the silicic acid tank, the acidity value was detected, the introduction of CO₂ was ended when the acidity value started to increase, and silicic acid was precisely separated; after the acidifying reaction in each tank was completed, a calcium salt, an aluminum salt, silicic acid and an alkaline solution were successively obtained after filtering, the obtained calcium salt, aluminum salt and silicic acid were separately dried to be directly used as products, or further treated by a known method to obtain calcium powders, aluminum oxide and silicon dioxide.

(3) The alkaline solution obtained by filtering in step (2) was concentrated and crystallized, and crystallization was performed by utilizing a different saturation solubility to obtain a potassium salt and a sodium salt.

(4) The sediment obtained in step (2) was dried and heated to 800° C., and then Cl₂ accounting for 100% of the mass of the sediment was introduced for reaction so as to obtain gaseous TiCl₄ and residue, and the gaseous TiCl₄ was cooled to 120° C. or below for being condensed, collected, rectified and purified to obtain a high-purity TiCl₄ liquid which was directly used as a product, or further treated by a known method to obtain titanium dioxide.

(5) The residue obtained in step (4) was cyclically washed with water, and then subjected to settling separation to obtain de-magnesium residue and a magnesium chloride solution, the magnesium chloride solution was filtered and then introduced into a magnesium hydroxide precipitation tank, and then sodium hydroxide was added into the above tank for reaction to obtain a magnesium hydroxide precipitate, sodium chloride was produced from an upper-layer liquid through evaporation and concentration equipment, the magnesium hydroxide precipitate was dried to obtain magnesium oxide, and the de-magnesium residue was a heavy metal-rich rare earth raw material.

### EXAMPLE 2

The resource comprehensive utilization process of the present disclosure was used to treat industrial solid wastes (red mud, fly ash, steel slag and coal gangue in a mass ratio of 5:1:1:1). The treatment steps are as follows:

(1) Industrial solid wastes were heated to 1800° C. by using a hydrogen furnace, and then

Na₂CO₃, O₂ and CO which respectively accounted for 78.9%, 19.6% and 29.5% of the mass of the industrial solid wastes were added and reacted for 200 min, followed by separating to obtain molten iron and liquid slag water.

(2) The liquid slag water separated in step (1) was cooled to 30° C. and then fed into a reactor, sodium nitrate accounting for 40% of the mass of the slag water was added, and then the above materials reacted for 24 h at 100° C. to obtain a reaction solution and sediment; the reaction solution was successively introduced into a calcium salt precipitation tank, an aluminum salt precipitation tank and a silicic acid tank, CO₂ was introduced into the above tanks for acidifying reactions respectively, the temperatures of all the acidifying reactions were set as 10° C., a CO₂ introduction amount and reaction time were adjusted according to the extent of the reaction in the tanks, a detection instrument and a control instrument were installed in the calcium salt precipitation tank, the CO₂ introduction amount and acidity value were controlled by detecting the numerical value of calcium ions, the introduction of CO₂ was ended when the content of calcium ions was detected as 0, and the calcium salt was precisely separated to ensure the purity of the product without the doping of silicon and aluminum; the detection instrument and the control instrument were installed in the aluminum salt precipitation tank, the CO₂ introduction amount and acidity value were detected by detecting the numerical value of aluminum ions, the introduction of CO₂ was ended when the content of aluminum ions was detected as 0, and the aluminum salt was precisely separated to ensure the purity of the product without the doping of silicon; a detection instrument and a control instrument were installed in the silicic acid tank, the acidity value was detected, the introduction of CO₂ was ended when the acidity value started to increase, and silicic acid was precisely separated; after the acidifying reaction in each tank was completed, a calcium salt, an aluminum salt, silicic acid and an alkaline solution were obtained after filtering, and the obtained calcium salt, aluminum salt and silicic acid were separately dried to be directly used as products, or further treated by a known method to obtain calcium powders, aluminum oxide and silicon dioxide.

(3) The alkaline solution obtained by filtering in step (2) was concentrated and crystallized, and crystallization was performed by utilizing a different saturation solubility to obtain a potassium salt and a sodium salt.

(4) The sediment obtained in step (2) was dried and heated to 600° C., and then Cl₂ accounting for 200% of the mass of the sediment was introduced for reaction so as to obtain gaseous TiCl₄ and residue, and the gaseous TiCl₄ was cooled to 120 w or below for being, condensed, collected, rectified and purified to obtain a high-purity TiCl₄ liquid which was directly used as a product, or further treated by a known method to obtain titanium dioxide.

(5) The residue obtained in step (4) was cyclically washed with water, and then subjected to settling separation to obtain de-magnesium residue and a magnesium chloride solution, the magnesium chloride solution was filtered and then introduced into a magnesium hydroxide precipitation tank, and then sodium hydroxide was added into the above tank for reaction to obtain a magnesium hydroxide precipitate, sodium chloride was produced from an upper-layer liquid through evaporation and concentration equipment, the magnesium hydroxide precipitate was dried to obtain magnesium oxide, and the de-magnesium residue was a heavy metal-rich rare earth raw material.

### EXAMPLE 3

The resource comprehensive utilization process of the present disclosure was used to treat industrial solid wastes (red mud and fly ash in a mass ratio of 1:1). The treatment steps are as follows:

(1) Industrial solid wastes were heated to 2000° C. by using a hydrogen furnace, then Na₂CO₃, O₂ and H₂ which respectively accounted for 20.2%, 3.2% and 5.4% of the mass of the industrial solid wastes were added and reacted for 60 min, followed by separating to obtain molten iron and liquid slag water.

(2) The liquid slag separated in step (1) was cooled to 100° C. and then fed into a reactor, sodium nitrate accounting for 10.2% of the mass of the slag water was added, and then the above materials reacted for 72 h at 300° C. to obtain a reaction solution and sediment; the reaction solution was successively introduced into a calcium salt precipitation tank, an aluminum salt precipitation tank and a silicic acid tank, CO₂ was introduced into the above tanks for acidifying reactions, respectively, the temperatures of all the acidifying reactions were set as 50° C., a CO₂ introduction amount and reaction time were adjusted according to the extent of the reaction in the tanks, a detection instrument and a control instrument were installed in the calcium salt precipitation tank, the CO₂ introduction amount and acidity value were controlled by detecting the numerical value of calcium ions, the introduction of CO₂ was ended when the content of calcium ions was detected as 0, the calcium salt was precisely separated to ensure the purity of the product without the doping of silicon and aluminum; a detection instrument and a control instrument were installed in the aluminum salt precipitation tank, the CO₂ introduction amount and acidity value were controlled by detecting the numerical value of aluminum ions, the introduction of CO₂ was ended when the content of aluminum ions was detected as 0, and the aluminum salt was precisely separated to ensure the purity of the product without the doping of silicon; the detection instrument and the control instrument were installed in the silicic acid tank, the acidity value was detected, the introduction of CO₂ was ended when the acidity value started to increase, and silicic acid was precisely separated; after the acidifying reaction in each tank was completed, a calcium salt, an aluminum salt, silicic acid and an alkaline solution were successively obtained after filtering, the obtained calcium salt, aluminum salt and silicic acid were separately dried to be directly used as products, or further treated by a known method to obtain calcium powders, aluminum oxide and silicon dioxide.

(3) The alkaline solution obtained by filtering in step (2) was concentrated and crystallized, and crystallization was performed by utilizing a different saturation solubility to obtain a potassium salt and a sodium salt.

(4) The sediment obtained in step (2) was dried and heated to 1300° C., and then Cl₂ accounting for 50% of the mass of the sediment was introduced for reaction so as to obtain gaseous TiCl₄ and residue, and the gaseous TiCl₄ was cooled to 120° C. or below for being, condensed, collected, rectified and purified to obtain a high-purity TiCl₄ liquid which was directly used as a product, or further treated by a known method to obtain titanium dioxide.

(5) The residue obtained in step (4) was cyclically washed with water, and then subjected to settling separation to obtain de-magnesium residue and a magnesium chloride solution, the magnesium chloride solution was filtered and then introduced into a magnesium hydroxide precipitation tank, and then sodium hydroxide was added into the above tank for reaction to obtain a magnesium hydroxide precipitate, sodium chloride was produced from an upper-layer liquid through evaporation and concentration equipment, the magnesium hydroxide precipitate was dried to obtain magnesium oxide, and the de-magnesium residue was a heavy metal-rich rare earth raw material.

### EXAMPLE 4

The resource comprehensive utilization process of the present disclosure was used to treat industrial solid wastes (red mud and coal gangue in a mass ratio of 3:2). The treatment steps are as follows:

(1) Industrial solid wastes were heated to 2200° C. by using a hydrogen furnace, then Na₂CO₃, O₂ and C which respectively accounted for 54.8%, 15.4% and 10.5% of the mass of the industrial solid wastes were added and reacted for 120 min, followed by separating to obtain molten iron and liquid slag water.

(2) The liquid slag separated in step (1) was cooled to 50° C. and then fed into a reactor, sodium nitrate accounting for 32.8% of the mass of the slag water was added, and then the above materials reacted for 36 h at 200° C. to obtain a reaction solution and sediment; the reaction solution was successively introduced into a calcium salt precipitation tank, an aluminum salt precipitation tank and a silicic acid tank, CO₂ was introduced into the above tanks for acidifying reactions, respectively, the temperatures of all the acidifying reactions were set as 25° C., a CO₂ introduction amount and reaction time were adjusted according to the extent of the reaction in the tanks, a detection instrument and a control instrument were installed in the calcium salt precipitation tank, the CO₂ introduction amount and acidity value were controlled by detecting the numerical value of calcium ions, the introduction of CO₂ was ended when the content of calcium ions was detected as 0, and the calcium salt was precisely separated to ensure the purity of the product without the doping of silicon and aluminum; the detection instrument and the control instrument were installed in the aluminum salt precipitation tank, the CO₂ introduction amount and acidity value were controlled by detecting the numerical value of the aluminum ions, the introduction of CO₂ was ended when the content of the aluminum ions was detected as 0, the aluminum salt was precisely separated to ensure the purity of the product without the doping of silicon; the detection instrument and the control instrument were installed in the silicic acid tank, the acidity value was detected, the introduction of CO₂ was ended when the acidity value started to increase, and silicic acid was precisely separated; after the acidifying reaction in each tank was completed, a calcium salt, an aluminum salt, silicic acid and an alkaline solution were obtained after filtering, and the obtained calcium salt, aluminum salt and silicic acid were separately dried to be directly used as products, or further treated by a known method to obtain calcium powders, aluminum oxide and silicon dioxide.

(3) The alkaline solution obtained by filtering in step (2) was concentrated and crystallized, and and crystallization was performed by utilizing a different saturation solubility to obtain a potassium salt and a sodium salt.

(4) The sediment obtained in step (2) was dried and heated to 1000° C., and then Cl₂ accounting for 150% of the mass of the sediment was introduced for reaction so as to obtain gaseous TiCl₄ and residue, and the gaseous TiCl₄ was cooled to 120° C. or below for being, condensed, collected, rectified and purified to obtain a high-purity TiCl₄ liquid which was directly used as a product, or further treated by a known method to obtain titanium dioxide.

(5) The residue obtained in step (4) was cyclically washed with water, and then subjected to settling separation to obtain de-magnesium residue and a magnesium chloride solution, the magnesium chloride solution was filtered and then introduced into a magnesium hydroxide precipitation tank, and then sodium hydroxide was added into the above tank for reaction to obtain a magnesium hydroxide precipitate, sodium chloride was produced from an upper-layer liquid through evaporation and concentration equipment, the magnesium hydroxide precipitate was dried to obtain magnesium oxide, and the de-magnesium residue was a heavy metal-rich rare earth raw material.

1. A resource comprehensive utilization process of red mud, fly ash, steel slag and coal gangue solid wastes, comprising the following steps:
(1) heating industrial solid wastes to 1800-2400° C., then adding Na₂CO₃, O₂ and a reducing agent for reaction, so as to separate molten iron and liquid slag water;
(2) cooling the liquid slag water separated from step (1) to 30-100° C. and then feeding the cooled liquid slag water into a reactor, adding a sodium salt, and reacting at 30-300° C. to obtain a reaction solution and sediment; and successively introducing the reaction solution into a calcium salt precipitation tank, an aluminum salt precipitation tank and a silicic acid tank, introducing CO₂ into the above tanks for acidification reaction, respectively, and then filtering to obtain a calcium salt, an aluminum salt, a silicic acid and an alkaline solution in sequence;
(3) concentrating and crystallizing the alkaline solution filtered in step (2), crystallizing separately to obtain a potassium salt and a sodium salt by utilizing a different saturation solubility;
(4) drying the sediment obtained in step (2), heating the dried sediment to 600-1300° C., introducing Cl₂ for reaction to obtain gaseous TiCl₄ and residue, cooling the gaseous TiCl₄ to 120° C. or below for being condensed and collected, to obtain liquid TiCl₄; and residue
(5) cyclically washing the residue obtained in step (4) with water, then performing settling separation to obtain de-magnesium residue and a magnesium chloride solution, introducing the magnesium chloride solution into a magnesium hydroxide precipitation tank, and then adding sodium hydroxide into the tank for reaction to obtain a magnesium hydroxide precipitate.

2. The resource comprehensive utilization process of red mud, fly ash, steel slag and coal gangue solid wastes according to claim 1, wherein in step (1), the solid waste is one or more of red mud, fly ash, steel slag and coal gangue.

3. The resource comprehensive utilization process of red mud, fly ash, steel slag and coal gangue solid wastes according to claim 2, wherein the red mud is Bayer red mud.

4. The resource comprehensive utilization process of red mud, fly ash, steel slag and coal gangue solid wastes according to claim 1, wherein in step (1), the addition amount of Na₂CO₃ is 20-80% of the mass of industrial solid wastes.

5. The resource comprehensive utilization process of red mud, fly ash, steel slag and coal gangue solid wastes according to claim 1, wherein in step (1), the addition amount of O₂ is 3-20% of the mass of industrial solid wastes.

6. The resource comprehensive utilization process of red mud, fly ash, steel slag and coal gangue solid wastes according to claim 1, wherein in step (1), the reducing agent is one or more of C, CO and H₂, and the addition amount of the reducing agent is 5-30% of the mass of the industrial solid waste.

7. The resource comprehensive utilization process of red mud, fly ash, steel slag and coal gangue solid wastes according to claim 1, wherein in step (2), the sodium salt is preferably sodium nitrate; and the addition amount of the sodium salt is 10-40% of the mass of the slag water.

8. The resource comprehensive utilization process of red mud, fly ash, steel slag and coal gangue solid wastes according to claim 1, wherein in step (2), the temperatures of all the acidification reactions are 10-50° C.

9. The resource comprehensive utilization process of red mud, fly ash, steel slag and coal gangue solid wastes according to claim 1, wherein in step (4), the addition amount of Cl₂ is 50-200% of the dry mass of the sediment.

10. The resource comprehensive utilization process of red mud, fly ash, steel slag and coal gangue solid wastes according to claim 1, wherein in step (5), sodium chloride is produced from an upper-layer liquid through evaporation and concentration equipment after the precipitation is completed in the magnesium hydroxide precipitation tank.
